(19) United States
(12) Patent Application Publication
(10) Pub. No.: US 2015/0208079 A1
(43) Pub. Date: Jul. 23, 2015

(54) ADAPTIVE FRAME TYPE DETECTION FOR REAL-TIME LOW-LATENCY STREAMING SERVERS

(71) Applicant: Nvidia Corporation, Santa Clara, CA (US)

(72) Inventors: Vinayak Pore, Pune (IN); Shashank Garg, Pune (IN); Sarvesh Satavalekar, Pune (IN); Thomas J. Meier, Santa Clara, CA (US)

(73) Assignee: Nvidia Corporation, Santa Clara, CA (US)

(21) Appl. No.: 14/160,643

(22) Filed: Jan. 22, 2014

(51) Int. Cl. H04N 19/50

(52) U.S. Cl. CPC H04N 19/50

(57) ABSTRACT

An enhanced display encoder system for a video stream source includes an enhanced video encoder that has parallel intra frame and inter frame encoding units for encoding a video frame, wherein an initial number of macroblocks is encoded to determine a scene change status of the video frame. Additionally, a video frame history unit determines an intra frame update status for the video frame from a past number of video frames, and an encoder selection unit selects the intra frame or inter frame encoding unit for further encoding of the video frame to support a wireless transmission based on the scene change status and the intra frame update status. A method of enhanced video frame encoding for video stream sourcing is also provided.

### TECHNICAL FIELD

This application is directed, in general, to video display generation and, more specifically, to an enhanced display encoder system and a method of enhanced video frame encoding for video streams.

### BACKGROUND

Real-time, low-latency video stream sourcing for client display is becoming increasingly more important in server-client applications. However, since a transmission stream of rendered frames is usually transmitted wirelessly, the video transmission stream has to be encoded with a source-side video encoder, which becomes an integral part of these low latency use cases. Such wireless transmissions may introduce various forms and amounts of interference and signal corruption. When decoded for client display, a loss of synchronization with the encoder may occur since corrupted frames may typically be used for frame prediction. Improvements in this area would prove beneficial to the art.

### SUMMARY

Embodiments of the present disclosure provide an enhanced display encoder system and a method of enhanced video frame encoding for video streams.

In one embodiment, the enhanced display encoder system for a video stream source includes an enhanced video encoder that has parallel intra frame and inter frame encoding units for encoding a video frame, wherein an initial number of macroblocks is encoded in the inter frame encoding unit to determine a scene change status of the video frame. Additionally, the enhanced display encoder system includes a video frame history unit coupled to the enhanced video encoder that determines an intra frame update status for the video frame from a past number of video frames and an encoder selection unit coupled to the video frame history unit that selects the intra frame or inter frame encoding unit for further encoding of the video frame to support a wireless transmission based on the scene change status and the intra frame update status.

In another aspect, the method of enhanced video frame encoding for video stream sourcing includes providing a video frame for encoding, providing parallel intra frame and inter frame encoding paths for the video frame and encoding an initial number of macroblocks in the inter frame encoding path. The method also includes determining a scene change status of the video frame from the initial number of macroblocks encoded, determining an intra frame update status for the video frame from a past number of video frames and selecting the intra frame or inter frame encoding path for further encoding based on the scene change status and the intra frame update status.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

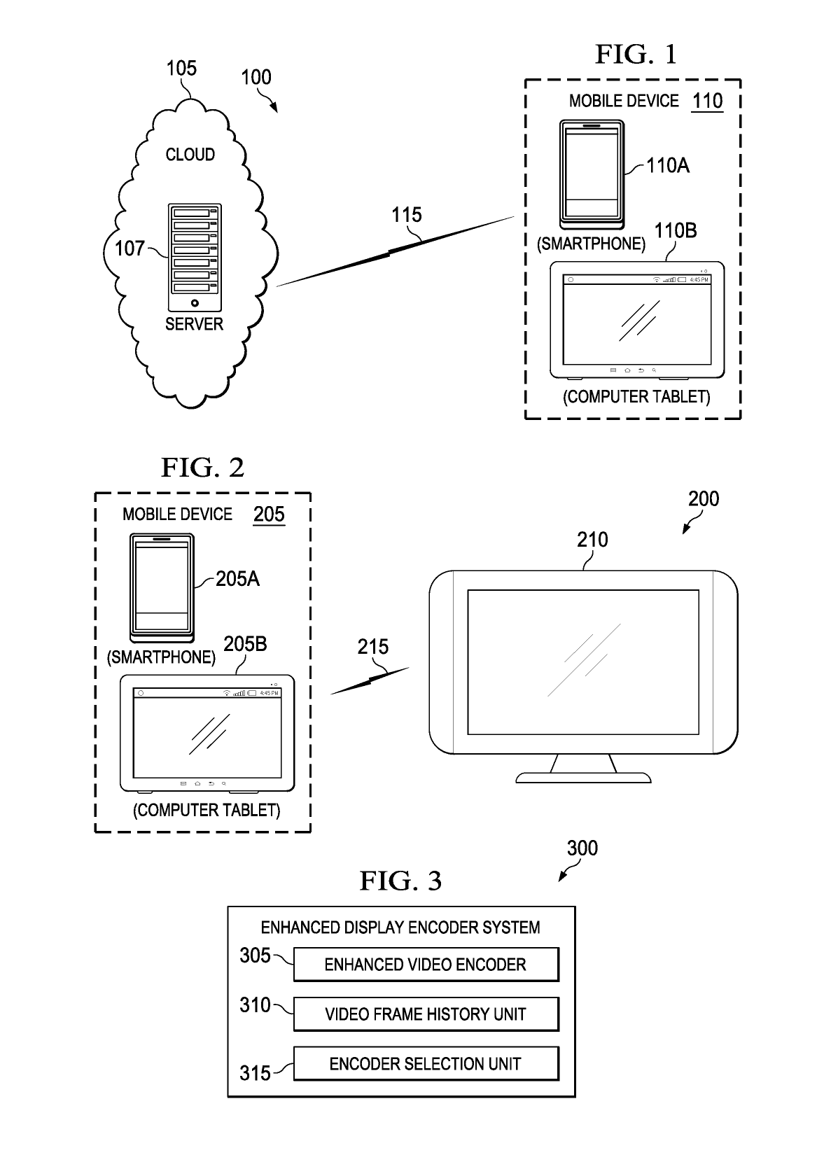

FIG. 1 illustrates a diagram of an embodiment of a cloud gaming arrangement constructed according to the principles of the present disclosure;

FIG. 2 illustrates a diagram of an embodiment of a Miracast display arrangement constructed according to the principles of the present disclosure;

FIG. 3 illustrates a diagram of an enhanced display encoder system as may be employed in a server such as the cloud server of FIG. 1 or a mobile device such as the mobile device of FIG. 2; and

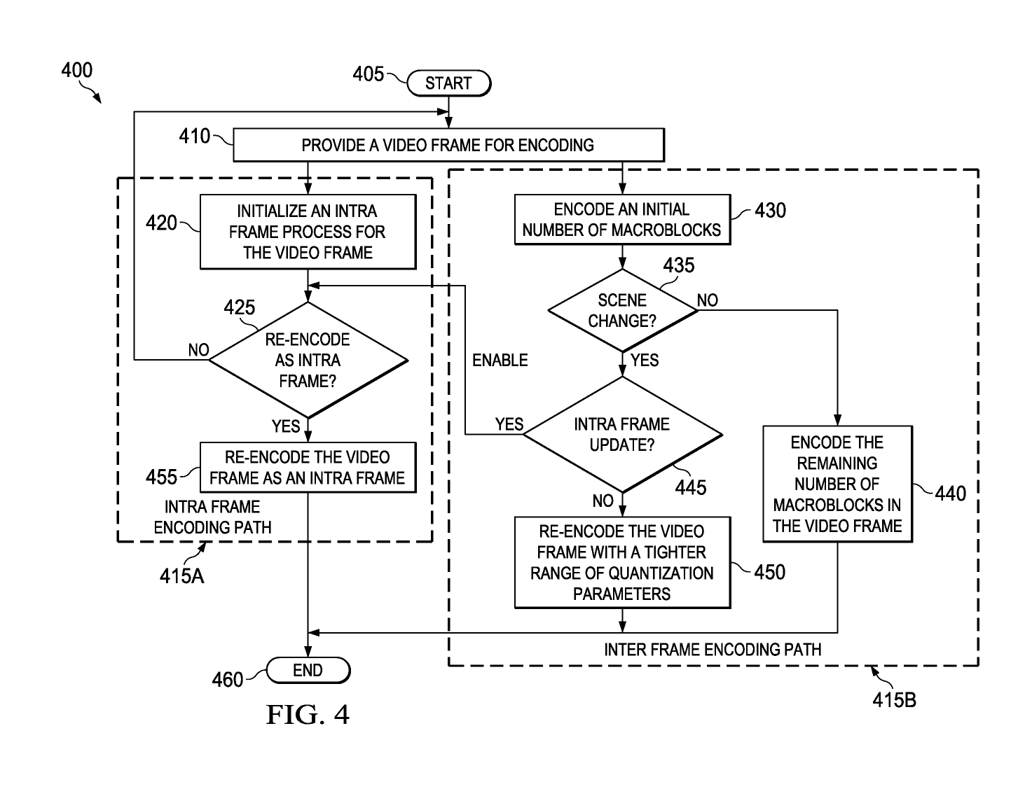

FIG. 4 illustrates a flow diagram of a method of enhanced video frame encoding for video stream sourcing carried out according to the principles of the present disclosure.

### DETAILED DESCRIPTION

Embodiments of the present disclosure apply, in general, to server-client remote computer graphics processing systems and provide real-time, low-latency video stream sourcing for client display. In such systems, graphics content is rendered as a video stream source, and frames of the rendered content are then captured and encoded. The encoded frames are then packetized and transmitted over a wireless network to a client as a video stream (that may typically also include audio). The client decodes the video stream and displays the content.

In one example, a video game is rendered on a server, and a user interacts through a client, which sends control data back to the server. Here, game graphics rendering on the server depends on this control data. Since the user is required to react quickly to the action on the client display, a minimal delay from server to client is required (e.g., typically below 100-200 milliseconds).

Miracast sources are another example of a remote computer graphics processing system. With the ever increasing processing power of handheld devices (e.g., smartphones and computer tablets), complex entertainment solutions are becoming more and more mobile. However, small display sizes remain a basic drawback of using these devices. The Miracast standard addresses these issues by providing a new class of use cases where a user is able to stream frames being rendered on the smaller display of a handheld device to a larger television display for a better display experience.

In order to curb a loss of synchronization in both of these examples, client or Miracast sinks may usually request that an intra frame be sent from a game server or Miracast source. This would reestablish the synchronization between the source and the sink. However, not all sinks may ask for an intra frame, and it is usually in the best interest of the source to regularly send intra frames. Unfortunately, the sending of an intra frame is costly in terms of encoding bits and too many intra frames would reduce the video quality dramatically since a wireless communication channel bandwidth is usually limited.

Therefore, embodiments of the present disclosure provide an adaptive determination of a video scene change and insertion of a video intra frame while conserving an encoding bit-budget. This adaptive determination employs a single pass rate control scheme where pre-analysis of an entire frame is not employed.

FIG. 1 illustrates a diagram of an embodiment of a cloud gaming arrangement, generally designated 100, constructed according to the principles of the present disclosure. The cloud gaming arrangement 100 includes a cloud network 105 employing a cloud server 107, a mobile device 110, which may be a smartphone 110A or a computer tablet 110B, and a wireless transmission link 115 that couples the cloud server 107 and the mobile device 110.

The cloud server 107 provides server-client remote computer graphics processing employing an enhanced display encoder system, which allows real-time, low-latency video stream sourcing for display on the mobile device 110. The cloud server 107 serves as a gaming server in this embodiment and maintains specific data about a game world environment being played, as well as data corresponding to the mobile device 110. The cloud server 107 provides a display that employs a stream of rendered video frames for encoding and transmission to the mobile device 110 over the wireless transmission link 115. The encoding is accomplished in the cloud server 107 by the enhanced display encoder system, which is discussed in more detail below.

FIG. 2 illustrates a diagram of an embodiment of a Miracast display arrangement, generally designated 200, constructed according to the principles of the present disclosure. The Miracast display arrangement 200 provides an example of remote computer graphics processing for Miracast sourcing. The Miracast display arrangement 200 includes a Miracast-enabled mobile device 205 (e.g., a smart phone 205A or a computer tablet 205B), a Miracast-enabled display unit 210 (e.g., a television) and a wireless transmission link 215 that couples the Miracast-enabled mobile device 205 and the Miracast-enabled display unit 210. The Miracast-enabled mobile device 205 provides server-client remote computer graphics processing employing an enhanced display encoder system, which allows real-time, low-latency video stream sourcing for display on the Miracast-enabled display unit 210.

The Miracast-enabled mobile device 205 employs a display that provides a stream of rendered video frames for encoding and transmission to the Miracast-enabled display unit 210 over the wireless transmission link 215. The encoding is accomplished in the Miracast-enabled mobile device 105 by the enhanced display encoder system, as noted earlier. The enhanced display encoder systems of FIGS. 1 and 2 are governed by a set of key features or constraints.

These key features generally include:
1) Maintaining a constant bit rate of the encoded stream with tighter control on each frame size.
2) Providing less encoding time since the encoded frame will have to be sent over wireless transmission links to the intended displays, which still have to decode it. (Longer encoding time contributes to higher latency.)
3) Maintaining quality of the encoded frames since any artifacts introduced may be much more noticeable if a larger display size is employed.
4) Recovering from errors that might be introduced due to the wireless transmission.

Therefore, embodiments of the present disclosure provide a novel scheme where a scene change is detected early and the necessary steps to maintain the above constraints are met.

FIG. 3 illustrates a diagram of an enhanced display encoder system, generally designated 300, as may be employed in a server such as the cloud server 107 of FIG. 1 or a mobile device such as the mobile device 205 of FIG. 2. The enhanced display encoder system 300 includes an enhanced video encoder 305, a video frame history unit 310 and an encoder selection unit 315.

The enhanced video encoder 305 includes parallel intra frame and inter frame encoding units for encoding a video frame provided corresponding to a display. Here, an initial number of macroblocks is encoded in the inter frame encoding unit to determine a scene change status of the video frame. The video frame history unit 310 is coupled to the enhanced video encoder 305 and determines an intra frame update status for the video frame from a past number of video frames. The encoder selection unit 315 is coupled to the video frame history unit 310 and selects the intra frame or inter frame encoding unit for further encoding of the video frame to support a wireless transmission based on the scene change status and the intra frame update status.

The process starts by first dividing the video frame into a number or group of macroblocks that can be independently decoded. This number of macroblocks may constitute as many as one or two slices of the video frame, where the video frame may consist of five slices, for example. For a scene change frame, a motion estimation will not be able to find a reference macroblock and a mode decision routine will indicate intra mode for such a macroblock.

By utilizing this suggestion from the mode decision routine, embodiments of the present scheme check for the number of intra macroblocks at the end of each number or group of macroblocks (or each slice). If the number of intra macroblocks is greater than or equal to a selected number (say 90 percent) of the total macroblocks initially encoded, the whole video frame is declared a scene change early and a re-encoding of the frame is triggered at that point, typically with a higher starting quantization parameter, in one example.

Based on a latency tolerance available, the scene change decision can be taken at the end of any number of macroblocks or slices. If a greater number of macroblocks or slices can be used for that decision, a more accurate declaration of the video frame as a scene change can be made. Since low-latency use cases operate on a basic premise of a quality versus latency trade-off, the present scheme provides a tool to be able to tune this trade-off, either statically or adaptively.

Another benefit of this approach is that for non-scene change frames, the encoding time remains a one-pass encoding time only. For a two-pass encoding, every frame is of course visited twice. Embodiments of the present approach use a “1.n pass” encoding time only for scene change frames and one-pass encoding otherwise. So, the present approach has a “revisit only if needed” adaptive nature.

FIG. 4 illustrates a flow diagram of a method of enhanced video frame encoding for video stream sourcing, generally designated 400, carried out according to the principles of the present disclosure. The method 400 starts in a step 405, and in a step 410, a video frame is provided for encoding. Then, an intra frame encoding path 415A and an inter frame encoding path 415B are provided in parallel for encoding the video frame.

In a step 420, an intra frame process is initialized for the video frame in the intra frame encoding path 415A. This initialization process saves setup time (hardware or software) if it is determined that an intra frame is required for the video frame. This intra frame initialization process may be further employed for the video frame as determined in a first decisional step 425.

In parallel with this initialization step 420, an initial number of macroblocks of the video frame are encoded in the inter frame encoding path 415B, in a step 430. Here, the initial number of macroblocks encoded may include a selectable quantity of macroblocks. For example, only a portion (e.g., a subset) of the initial macroblocks may be selectable. Alternately, the total number of initial macroblocks may be selectable. Additionally, these initial macroblocks may be selected from anywhere in the video frame (i.e., they do not need to be contiguous). Alternately, the initial number of macroblocks encoded may correspond to one or two slices of the video frame, which may also be selected from anywhere in the video frame.

A scene change status of the video frame is determined from the initial number of macroblocks encoded in a second decisional step 435. Here, determining the scene change status may include employing a selectable percentage of the initial number of macroblocks to indicate the scene change status of the video frame.

For a negative scene change status in the second decisional step 435 indicating that a scene change has not occurred, the method 400 selects the inter frame encoding path 415B for further encoding where an inter frame encoding of the remaining number of macroblocks is performed, in a step 440. At the conclusion of the step 440, the method 400 ends in a step 460.

For a positive scene change status in the second decisional step 435 indicating that a scene change has occurred, the method 400 continues to a third decisional step 445. An intra frame update status for the video frame is determined from a past number of video frames, in the third decisional step 445. Here, determining the intra frame update status may include employing a selectable quantity of the past number of video frames to indicate the intra frame update status of the video frame. For example, a frame quantity such as 500 past frames (e.g., five seconds worth of past frames) may be employed to indicate that an intra frame is required or recommended. Alternately, a fixed frame quantity may be employed.

For a negative intra frame update status in the third decisional step 445 indicating that an intra frame update has not occurred, the method 400 again selects the inter frame encoding path 415B for further encoding where an inter frame re-encoding of the video frame is performed, in a step 450. Here the video frame is re-encoded employing a tighter range of quantization parameters across all macroblocks of the video frame for a positive scene change status and a negative intra frame update status. At the conclusion of the step 450, the method 400 ends in a step 460. For a positive intra frame update status in the third decisional step 445 indicating that an intra frame update indication has occurred, the method 400 returns to the first decisional step 425.

The positive intra frame update status from the third decisional step 445 provides a return to the intra frame encoding path 415A wherein it additionally provides an enabling feature to the second decisional step 425 thereby allowing a re-encoding of the video frame as an intra frame in a step 455. At the conclusion of the step 455, the method 400 ends in the step 460. When the enabling feature to the second decisional step 425 is not provided, the method 400 returns to the step 410 since the outcome of the step 420 may change from frame to frame.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A method of enhanced video frame encoding for video stream sourcing, comprising:
providing a video frame for encoding;
providing parallel intra frame and inter frame encoding paths for the video frame;
encoding an initial number of macroblocks in the inter frame encoding path;
determining a scene change status of the video frame from the initial number of macroblocks encoded;
determining an intra frame update status for the video frame from a past number of video frames; and
selecting the intra frame or inter frame encoding path for further encoding based on the scene change status and the intra frame update status.

2. The method as recited in claim 1 wherein the video frame is selected from the group consisting of:
a server; and
a mobile device.

3. The method as recited in claim 2 wherein the mobile device is a smartphone or a computer tablet.

4. The method as recited in claim 1 wherein the initial number of macroblocks encoded corresponds to one or two slices of the video frame.

5. The method as recited in claim 1 wherein encoding the initial number of macroblocks includes a selectable quantity of macroblocks.

6. The method as recited in claim 1 wherein determining the scene change status includes employing a selectable percentage of the initial number of macroblocks to indicate the scene change status of the video frame.

7. The method as recited in claim 1 wherein determining the intra frame update status includes employing a selectable quantity of the past number of video frames to indicate the intra frame update status of the video frame.

8. The method as recited in claim 1 wherein selecting the inter frame encoding path for further encoding includes an inter frame encoding of the remaining number of macroblocks for a negative scene change status.

9. The method as recited in claim 1 wherein selecting the inter frame encoding path for further encoding includes re-encoding the video frame with a tighter range of quantization parameters employed across all macroblocks of the video frame for a positive scene change status and a negative intra frame update status.

10. The method as recited in claim 1 wherein selecting the intra frame encoding path for further encoding includes re-encoding the video frame as an intra frame for a positive scene change status and a positive intra frame update status.

11. An enhanced display encoder system for a video stream source; comprising:
an enhanced video encoder that includes parallel intra frame and inter frame encoding units for encoding a video frame, wherein an initial number of macroblocks is encoded in the inter frame encoding unit to determine a scene change status of the video frame;
a video frame history unit coupled to the enhanced video encoder that determines an intra frame update status for the video frame from a past number of video frames; and
an encoder selection unit coupled to the video frame history unit that selects the intra frame or inter frame encoding unit for further encoding of the video frame to support a wireless transmission based on the scene change status and the intra frame update status.

12. The system as recited in claim 11 wherein a video stream sourcing unit is selected from the group consisting of:
a server; and
a mobile device.

13. The system as recited in claim 11 wherein the initial number of macroblocks encoded corresponds to one or two slices of the video frame.

14. The system as recited in claim 11 wherein the initial number of macroblocks includes a selectable quantity of macroblocks.

15. The system as recited in claim 11 wherein a selectable percentage of the initial number of macroblocks encoded is employed to indicate the scene change status of the video frame.

16. The system as recited in claim 11 wherein a selectable quantity of the past number of video frames is employed to indicate the intra frame update status of the video frame.

17. The system as recited in claim 11 wherein the further encoding includes an inter frame encoding of the remaining number of macroblocks for a negative scene change status.

18. The system as recited in claim 11 wherein the further encoding includes an inter frame re-encoding of the video frame with a tighter range of quantization parameters employed across all macroblock encoding of the video frame for a positive scene change status and a negative intra frame update status.

19. The system as recited in claim 11 wherein the further encoding includes an intra frame re-encoding of the video frame for a positive scene change status and a positive intra frame update status.

20. The system as recited in claim 11 wherein a display unit is selected from the group consisting of:
a mobile device; and
a television.
